(19) United States
(12) Patent Application Publication
(10) Pub. No.: US 2019/0308374 A1
(43) Pub. Date: Oct. 10, 2019

(54) HIGH RESOLUTION IMAGE COUNTERTOP

(71) Applicant: DAVID HARDER, BOISE, ID (US)

(72) Inventor: DAVID HARDER, BOISE, ID (US)

(21) Appl. No.: 16/378,305

(22) Filed: Apr. 8, 2019

Related U.S. Application Data
(60) Provisional application No. 62/654,150, filed on Apr. 6, 2018.

(51) Int. Cl. B29C 65/00; B41M 1/30; B05D 7/00

(52) U.S. Cl. CPC B29C 66/71; B29L 2031/441; B05D 7/57; B41M 1/30

(57) ABSTRACT

What is disclosed is a method of finishing a countertop to provide for the appearance of a material, such as stone, wood, or otherwise, but utilizing a high resolution image of the actual material instead of the material itself. The image is preferably printed in high resolution on a vinyl substrate, then adhered to the countertop. Preferably a clear coat layer is then applied to protect the vinyl substrate. This clear coat can be a urethane sprayed onto the vinyl. The disclosed method provides for a less expensive mechanism to provide or change the appearance of a countertop.

### TECHNICAL FIELD

The disclosure generally relates to the field of countertop manufacturing and refinishing. Particular embodiments relate to the construction or retrofitting of a countertop with a high resolution photographic image of a material displayed on the countertop.

### DETAILED DESCRIPTION OF THE EXEMPLARY PROCESS

While the presently disclosed inventive concept(s) is susceptible of various modifications and alternative constructions, certain illustrated embodiments thereof have been shown in the drawings and will be described below in detail. It should be understood, however, that there is no intention to limit the inventive concept(s) to the specific form disclosed, but, on the contrary, the presently disclosed and claimed inventive concept(s) is to cover all modifications, alternative constructions, and equivalents falling within the spirit and scope of the inventive concept(s) as defined herein.

In the following description, like elements are identified with like references. The use of “e.g.,” “etc,” and “or” indicates non-exclusive alternatives without limitation unless otherwise noted. The use of “including” means “including, but not limited to,” unless otherwise noted.

Countertops made of stone, such as granite or marble, are currently very popular in the United States. However, these countertops are typically more expensive than synthetic countertops, such as Corian® countertops or laminate countertops. While more expensive, many consumers find the aesthetic appearance of natural materials to be preferable to that of less expensive synthetic material. Natural stone materials also produce a negative impact on the environment as these materials must be quarried and transported from their natural location to the location of the home owner.

In addition to the expense and weight of installing natural countertops, pre existing homes typically have countertops installed when the home is built. In order to replace the pre-existing countertop with one of natural materials, the old countertop is typically removed, discarded, and replaced with a natural countertop. Thus what is needed is a less expensive method and system for providing a countertop with the appearance of being of natural materials, but without the expense, weight, or waste of replacing an old countertop in its entirety.

What is disclosed is a process and method for installing a countertop or finishing/refinishing a countertop to have a decorative appearance, preferably a continuous decorative appearance to provide the appearance that the entire countertop is continuous such as a continuous granite countertop. The term countertop can be construed broadly to include tables, chairs, desktop or other item(s) of furniture. In a preferred embodiment this decorative appearance is that of a natural material such as stone or wood. The image preferably has at least 300dpi resolution at 24″×12″ or larger to maintain at least 100dpi resolution when the image is expanded to countertop or desired surface size.

In order to provide a high quality image in a format that can be adhered to a countertop, the image is preferably printed with a full color large format printer to minimize pattern “seams” to maintain realistic look of natural elements. The image is preferably printed on high quality adhesive vinyl. A protective laminate, preferably clear, can be added to protect the vinyl or omitted in order to provide a solid feel to the countertop.

To prepare the surface of the countertop any caulking or surface contaminants are first removed along with any oil based materials or anything that would interfere with the adhesion of an image to the surface. Any gaps are filled and sanded smooth such that any gap or edge that is 1/16″ or larger as to not visible through the vinyl. For rough edges such as a the edge of wood, or in hard to get reach adhesion areas, urethane is applied to the substrate to provide the vinyl a smooth surface to wrap past the visible area. An example of a hard to reach or rough area would be beneath a counter edge.

The vinyl image is prepared for adherence to the countertop. Typically this includes wiping down with microfiber cloth using isopropyl alcohol 90%. Static electricity is then removed from the vinyl, for example by wiping with a dryer sheet. A tack cloth is utilized to remove any dust or debris from the vinyl.

The high resolution photographic image embodied in the vinyl is then adhered to a countertop. In order to apply the image to the countertop, the surface of the countertop (also called herein the “substrate”) is first wiped with acetone or laquer thinner to remove any lingering contaminants. The vinyl is applied with the installer removing any air bubbles by smoothing with a vinyl tool, torching to consolidate air pockets, or needling the vinyl. The front edges of the substrate are wrapped to give the appearance of a solid piece of material, such as stone or wood. For a rough edged surface or hard to get adhesion areas, vinyl adhesion promoters (For example Probond®) are used. The vinyl is applied and wraped past the visible area (for example under a countertop edge) at least an ⅛″ for added durability and adhesion. The vinyl image can further be applied to a tile, wood, or solid surface backsplash to provide a uniform appearance with the countertop or alternatively if contrasting backsplash is desired a different image can be utilized.

The countertop substrate can be a newly manufactured countertop or a preexisting countertop. An ideal use of the process is to refinish pre-existing countertops to have the appearance of stone, such as granite, marble, travertine, limestone, slate, or of a wood or other image. The process allows for a countertop to have the appearance of stone or wood but with a significantly lower weight, cost, and/or ease of installation.

To retrofit a countertop, the countertop is first cleaned to provide for an adequate bond. The surface is preferably then primed for adhesion of a high resolution image. In a preferred embodiment, the high resolution, high quality image is an image of a typical countertop material, stone, wood, concrete, or other material that is printed on a substrate. In a preferred embodiment the substrate is a vinyl substrate. In a preferred embodiment the substrate is provide with an adherent pre-applied to the bottom of the vinyl substrate with a backing paper positioned on the adhesive to protect it and prevent premature bonding. The vinyl backing paper is then removed and the vinyl is positioned on the substrate countertop. The image and substrate can be manufactured with pre-determined dimensions or cut to shape by the installer to the size of the area of the countertop on which it is to be applied. In a preferred embodiment the image occupies the full surface of the countertop, including vertical edges of the countertop.

A needle roller or other tool or method can then be used to remove any air trapped beneath the vinyl graphic. A clear graphic and surface protection film, such as Scotch Guard, is then applied over the substrate displaying the graphic to protect the graphic image. Alternatively the clear film is pre-installed to the substrate. In a preferred embodiment, the surface protection film is then abraded prior to applying a clear coat to the graphic.

In a preferred embodiment a clear coat is then applied to the graphic. Preferably the clear coat is a spray on urethane applied over the vinyl. Preferably three even coats of urethane are sprayed over the vinyl and allowed to cure. Subsequently three addition coats of urethane in a high gloss, low gloss, satin, or spattered finish (such as for a textured stone type finish when sanded). The urethane provides added durability to the vinyl as well as a waterproofing finish in potential hazard areas, such as above a dishwasher.

Alternatively a spray on or roll on acrylic can be directly added to the clear film or image. The acrylic can suffice as a final layer or alternatively a layer of epoxy can be added. In a preferred embodiment the clear coat is a high solids clear epoxy resin. A flame is applied to any vertical countertop sections, such as edges of the countertop, in order to remove any air bubbles trapped in the clear coat. The epoxy is then allowed to cure. A bonding agent for adhering a UV protectant to the epoxy is then applied to the surface of the epoxy. Prior to the application of the bonding agent to the epoxy the surface of the epoxy can be abraded. A UV protectant, such as a spray on acrylic urethane or other spray or roll on acrylic is then applied to the clear coat in a preferred embodiment. In a preferred embodiment the acrylic serves to protect the epoxy and/or the substrate from harmful ultraviolet (UV) radiation.

After the clear coat cures or dries the clear coat is polished. A wet sand with fine grit sand paper is preferably used to polish the clear coat. To provide a stone textured finish, the clear coat is polished with wet sand with fine grit sand paper then lightly buffed to provide a stone textured surface. Any edges of the vinyl are cut with a sharp blade to provide an edge of the countertop. Caulking can then be applied to seal the edge of the countertop or other surface.

Still other features and advantages of the presently disclosed and claimed inventive concept(s) will become readily apparent to those skilled in this art from the following detailed description describing preferred embodiments of the inventive concept(s), simply by way of illustration of the best mode contemplated by carrying out the inventive concept(s). As will be realized, the inventive concept(s) is capable of modification in various obvious respects all without departing from the inventive concept(s). Accordingly, the drawings and description of the preferred embodiments are to be regarded as illustrative in nature, and not as restrictive in nature.

While certain exemplary embodiments are described in this disclosure, it is to be distinctly understood that the presently disclosed inventive concept(s) is not limited thereto but may be variously embodied to practice within the scope of this disclosure. From the foregoing description, it will be apparent that various changes may be made without departing from the spirit and scope of the disclosure as defined herein.

What is claimed is:

1. A method of preparing a countertop, said method comprising the following steps:
the step of preparing a countertop base for application of a substrate comprising a high resolution photographic image;
the step of adhering said substrate comprising a high resolution image to said countertop;
the step of applying a protective clear layer to said substrate.

2. The method of claim 1, wherein said base comprises a pre-existing countertop.

3. The method of claim 1, wherein said substrate comprises a vinyl substrate.

4. The method of claim 1, wherein said method comprises the step of cutting said vinyl substrate to the approximate dimensions of said countertop.

5. The method of claim 1, wherein said high resolution photographic image is an image of a natural material.

6. The method of claim 1, wherein said protective clear layer comprises an epoxy resin.

7. The method of claim 1, wherein said protective clear layer comprises an acrylic.

8. The method of claim 6, wherein said method comprises the step of applying a UV protectant to said protective clear layer.

9. The method of claim 1, wherein said method comprises the step of obtaining a substrate comprising a high resolution photographic image, wherein said substrate has the dimensions of said countertop.

10. The method of claim 1, wherein said method comprises the step of removing air bubbles from said protective clear coat.

11. The method of claim 1, wherein said method comprises the step of printing a high resolution image to said substrate.

12. The method of claim 1, wherein said protective clear layer comprises a spray on urethane.

13. The method of claim 12, wherein said spray on urethane is applied in three even coats.
